(19) United States
(12) Patent Application Publication
(10) Pub. No.: US 2005/0028968 A1
(43) Pub. Date: Feb. 10, 2005

(54) Temperature control system for a vehicle and method of operating a temperature control system for a vehicle

(76) Inventors: Uwe Kohle, Deizisau (DE); Patric Schlecht, Ostfildern (DE); Andreas Collmer, Ostfildern (DE); Gunter Eberspach, Wolfschlugen (DE)

Correspondence Address: M. Robert Kestenbaum, 11011 Bermuda Dunes NE, Albuquerque, NM, 87111, US

(21) Appl. No.: 10/899,946

(22) Filed: Jul. 26, 2004

(30) Foreign Application Priority Data
Aug. 7, 2003 (DE) 103 36 248.7

(51) Int. Cl. B60H 3/00; B61D 27/00; B60H 1/00; B60H 1/32

(52) U.S. Cl. 165/202; 165/42

(57) ABSTRACT

A temperature control system for a vehicle includes an evaporator of an air conditioning unit, heat and/or moisture being withdrawable by the evaporator from the air to be introduced into the vehicle interior, a first heat exchanger arrangement, downstream of the evaporator in the air flow direction, supply of heat to air to be introduced into the vehicle interior being by the heat exchanger arrangement, and a heating arrangement with a second heat exchanger arrangement upstream of the evaporator in the air flow direction, supply of heat to the air to be introduced into the vehicle interior by the second heat exchanger arrangement.

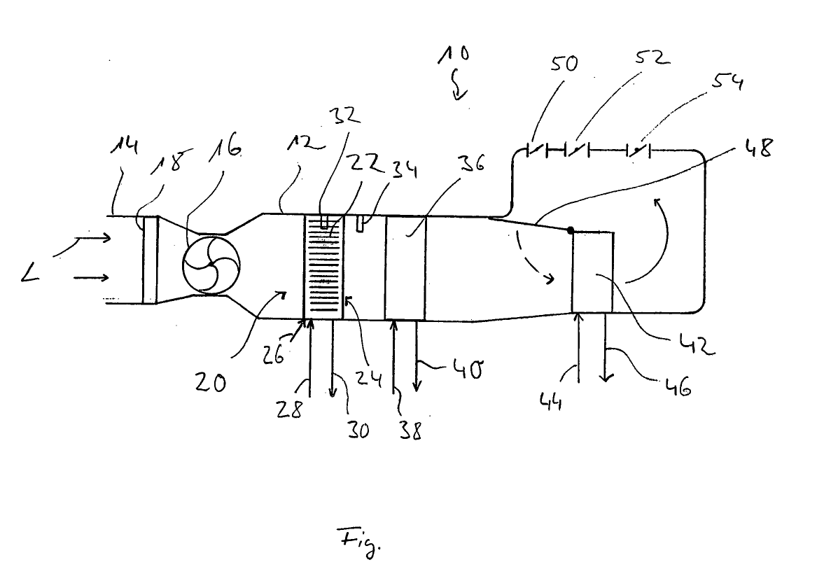

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to a temperature control system for a vehicle, and to a method of operating such a temperature control system for a vehicle.

2. Description of the Related Art

In modern motor vehicles, the air to be introduced into the vehicle interior can be temperature-controlled in various ways. For one, it is possible to cool the air introduced into the vehicle interior, or to remove air moisture from the same, by activating an air conditioning unit, for which purpose such air conditioning units in general have an evaporator through which a refrigerant flows, a cooling action being produced by refrigerant evaporation and heat being withdrawn from the air flowing around the evaporator. Furthermore it is known in general that by heat transfer from the cooling circuit of an internal combustion engine to the air being introduced into the vehicle interior, this air can be heated. Furthermore it is known on the one hand to prepare hot air by simultaneous operation of the air conditioning unit and by heat transfer from the cooling circuit of the internal engine to the air to be introduced, and on the other hand to introduce air, from which at least a certain proportion of moisture has been removed, into the vehicle interior. This mode of operation is above all selected at comparatively low external temperatures and for example during rain, in order to prevent fogging of the windows, and likewise however to be able to provide pleasant temperatures in the vehicle interior.

A problem with such systems consists in that in the evaporator used in the air conditioning unit and around which flows air to be introduced into the vehicle interior, and at first transporting a comparatively high proportion of moisture, because of a spongy or lamellar structure, which is required in order to reach a high power density, moisture collects. This can have the consequence that microbial growth occurs in the region of this evaporator, or because of excessive collection of moisture, fogging of the windshield cannot be prevented.

### BRIEF SUMMARY OF THE INVENTION

The present invention has as its object to provide a temperature control system for a vehicle and a method of operating such a temperature control system, by means of which the fogging of vehicle windows can be prevented in a convenient manner, with an improved hygienic ambience.

According to the invention, this object is attained by a temperature control system for a vehicle, comprising an evaporator of an air conditioning unit, the evaporator being capable of withdrawing heat and/or moisture from air to be introduced into a vehicle interior, a first heat exchanger arrangement downstream of the evaporator in the air flow direction, the first heat exchanger arrangement being capable of supplying heat to the air to be introduced into the vehicle interior, and a heating arrangement with a second heat exchanger arrangement upstream of the evaporator in the air flow direction, the second heat exchanger arrangement being capable of supplying heat to the air to be introduced into the vehicle interior.

In the temperature control system according to the invention there are thus present two regions or two heat exchanger arrangements, in which heat can be transferred to the air to be introduced into the vehicle interior. One of these heat exchanger arrangements is arranged upstream of the evaporator, while the other one is located downstream. The heat exchanger arrangement positioned upstream of the evaporator can be used for preheating the air flowing onto the evaporator, and can reduce the collection of moisture in the region of the evaporator by this air heating and corresponding heating of the evaporator, and can also markedly reduce microbial growth there.

According to an aspect of the present invention, it can be provided that the heat transfer capability of the first heat exchanger arrangement and the heat transfer capability of the second heat exchanger arrangement are variable in a mutually balanced manner. By the balancing of the heat transfer capability of the two heat exchanger arrangements, it becomes possible, for example, with a desired interior temperature predetermined by a passenger and simultaneously activated air conditioning unit, to ensure that an additional operation of the heating arrangement with the second heat exchanger arrangement cannot lead to an excessive heating of the air to be introduced into the vehicle interior, since by the balancing of the heat transfer capacities in a corresponding manner the first heat exchanger arrangement can then be throttled back as regards heat transfer.

It can for example be provided for this purpose that the heat transfer capability of the first heat exchanger arrangement can be changed by changing the flow guiding of the air to be introduced into the vehicle interior. It is furthermore possible that the heat transfer capability of the second heat exchanger arrangement can be varied by changing the heating power of the heating arrangement.

In an embodiment, the heating arrangement can include a fuel-operated heating device. This confers the advantage that the system according to the invention can additionally be used to fulfill the function of a stationary heating means. It is of course furthermore possible to use other energy sources as heating devices. For example, the heating arrangement can also include a fuel-operated heating device, an electrically operable heat source, an auxiliary energy source, preferably fuel cell or mechanically or thermodynamically operated auxiliary energy source, and also a vehicle drive assembly.

The first heat exchanger arrangement can for example be fed by the cooling system of an internal combustion engine, so that the heat taken from an internal combustion engine can be used in a meaningful manner.

According to a further aspect, the object mentioned hereinabove can be attained by a method of operating a temperature control system according to the invention, in which method for example with an active evaporator the first heat exchanger arrangement and the second heat exchanger arrangement are at least from time to time active simultaneously for transferring heat to the air to be introduced into the vehicle interior.

As described hereinabove, by the simultaneous operation at least from time to time of the two heat exchanger arrangements, it can be ensured on the one hand that the air to be introduced into the vehicle interior has the desired temperature, in particular also with energy-efficient use of the heat arising in the region of an internal combustion engine or other heat source, and that on the other hand, however, in the region of the evaporator the danger of excessive moisture collection and microbial growth is markedly reduced.

In this method it can for example be provided that with an activated first heat exchanger arrangement, when the evaporator is activated, the heating arrangement with the second heat exchanger arrangement is activated and the heat transfer capability of the first heat exchanger arrangement is reduced.

### BRIEF DESCRIPTION OF THE DRAWING

The present invention is described hereinafter with reference to the accompanying FIGURE, which shows the principles of a temperature control system according to the invention, of a modular construction.

### DETAILED DESCRIPTION OF THE INVENTION

The temperature control system 10 shown in the FIGURE and for example of modular construction can be substantially completely installed in a housing 12, which of course can be formed by plural housing portions joined together. In an inlet region 14, the air to be introduced into the vehicle interior and also to be thermally treated is introduced into this temperature control system 10 according to the invention. This air L to be introduced into the vehicle interior is forwarded by an air forwarding fan 16 which is positioned downstream of a filter 18 in the air flow direction.

The air L then flows to a heating arrangement generally denoted by 20 and for example having a fuel-operated heating device and a heat exchanger arrangement 24, represented by plural cooling ribs 22. Fuel 26 and combustion air 28 are supplied to the heating device, and the combustion products 30 then leave the heating device or the heating arrangement 20 via an associated outlet. An overheating sensor 32 can also be allocated to the heating device, as well as a temperature sensor 34 positioned downstream of the same to determine the temperature of the air L after this has flowed past the heating arrangement 20 or respectively the heat exchanger arrangement 24 of the same.

In the air flow direction, there then follows after this heating arrangement 20 an evaporator 36 of an otherwise not shown air conditioning unit. Liquid refrigerant 38 is supplied to this evaporator 36, is evaporated therein, taking up heat, and is discharged again as refrigerant vapor 40. With this evaporation, heat is withdrawn from the air flowing around the evaporator 36 and to be introduced into the vehicle interior.

Further downstream of the evaporator 36 a further heat exchanger arrangement 42 is provided. Hot cooling medium 44 from a cooling circuit of an internal combustion engine or the like is supplied to this. With the heat exchanger arrangement 42 activated, this cooling medium transfers heat to the air to be introduced into the vehicle interior, so that the cooling medium leaves the heat exchanger arrangement 42 as somewhat colder cooling medium 46 and flows, for example, to a further heat exchanger or back again to the internal combustion engine or another heat source.

A flow changeover element generally denoted by 48 is furthermore provided, for example flap-like, and can be brought by a drive (not shown) into different positions. In the position shown in the FIGURE, this element 48 is set such that substantially the whole of the air supplied and to be introduced into the vehicle interior is conducted in the direction toward the heat exchanger arrangement 42, so that substantially the whole of the air to be introduced into the vehicle interior is heated by corresponding heat transfer, and is then delivered into the vehicle interior by means of numerous separately adjustable inlet elements 50, 52, 54 at desired positioning in the vehicle interior. If the element 48 is pivoted as indicated by the dashed arrow in the FIGURE, at least a portion of the air to be introduced into the vehicle interior does not flow toward the heat exchanger arrangement 42, but directly to the elements 50, 52 and 54, in order to be conducted via these to desired positions in the vehicle interior. It is possible to displace or pivot the element 48 so far that the heat exchanger arrangement 42 is completely deactivated, and thus the whole of the air to be introduced into the vehicle interior cannot flow to the heat exchanger arrangement 42 and thus also cannot take up heat in this.

The various system regions of the temperature control system according to the invention which are to be driven, i.e. the fan 16, the heating arrangement 20, the air conditioning unit (not shown in further detail), and the element 48 or the drive allocated to this, are of course driven by an allocated drive system, in order to set the various system regions in operation, either by default standards according to prescribed routines or by user defaults, to change their state of operation, or to set these out of operation again.

If a temperature control system 10 is to be operated in a state in which on the one hand comparatively low external temperatures prevail, and on the other hand a very high air humidity is however present, as can be the case in rain, a vehicle occupant may desire, on the one hand to heat the air, and on the other hand to conduct dry air into the vehicle interior, in order to prevent fogging of the windows. Besides the air conditioning unit and thus the evaporator 36, the heat exchanger arrangement 42 is also active. By the operation of the air conditioning unit, the air L to be introduced into the vehicle interior is on the one hand cooled, and on the other hand moisture is also removed from it. By the operation or activation of the heat exchanger arrangement 42, this cooled and dried air is then heated again in order to introduce it into the vehicle interior at the desired temperature.

In this operating state according to the present invention it is further provided that by activation or operation of the heating arrangement 20 the air L flowing to the evaporator 36 is already preheated. This preheating has the consequence that the moisture deposition in the region of the evaporator 36 is reduced, which also reduces the danger of microbial growth. Of course, on connecting up the heating arrangement 20, the heat exchanger arrangement 42 then has to be throttled in its heat transfer capability, in order to make sure that air introduced into the vehicle interior in fact has the temperature desired by the passenger. In this operating state, it is not necessary for the two heat exchanger arrangements 24 and 42 to be active simultaneously over the whole period. For example, the heating arrangement 20 can be set in operation at intervals, and then in a corresponding manner the heat transfer capability of the heat exchanger arrangement 42 can be reduced at intervals.

In a phase in which the air conditioning unit and thus the evaporator 36 is not active, but in which, for example, because of its previous operation it is to be assumed that a considerable amount of moisture has collected in the region of the evaporator 36, the heating arrangement 20 can likewise be activated in order, by heat transfer to the air to flow to the evaporator 36, to carry away moisture present there and thus in principle to dry the evaporator 36. This kind of operation is preferably also undertaken when it is anyway desired that the air to be introduced into the vehicle interior be heated, which in general takes place with the use of the heat exchanger arrangement 42. In this case the heat exchanger arrangement 42 can thus again be throttled in its heat exchange capability, so that a portion of the heat to be transported with the air into the vehicle interior is transferred by this and another portion by means of the heat exchanger arrangement 24.

Furthermore it is of course possible with the temperature control system 10 according to the invention to set the heating arrangement 20 alone in operation, for example in a stationary heating mode or in an operating state in which, after starting an internal combustion engine, sufficient heat is not yet produced in its cooling circuit to be able to heat air to be introduced into the vehicle interior in the region of the heat exchanger arrangement 42.

The present invention has been described hereinabove such that the heating arrangement 20 includes a fuel-operated heating device, not further shown. It is of course possible to provide the heat to be transferred to the air upstream of the evaporator 36 by means of other heat sources. Thus the heating arrangement 20 can also include an electrically operable energy source, which either transfers the heat generated there to a fluid circulating through the heat exchanger arrangement 24, or which is incorporated directly in the air stream and thus provides the heat exchanger arrangement 24 by means of its heated surface itself. In particular, so-called PTC elements can be used for this, which are positioned in the air stream before the evaporator 36. As energy sources for such electrically operable heating devices, there are for example a generator producing electricity in vehicle operation, a battery of the vehicle, solar cells integrated into roof modules or other auxiliary energy devices, such as, e.g., a fuel cell or a mechanically driven auxiliary device such as e.g. thermodynamically working motor with generator. It is also possible for the heat or a portion of it which is generated in a drive assembly and is in general used for heating the air to be introduced into the vehicle interior, to be fed into the air flow by means of the heat exchanger arrangement 24 upstream of the evaporator 36 and in this manner to make sure of moisture removal by means of preheated air.

1. Temperature control system for a vehicle, comprising:
an evaporator (36) of an air conditioning unit, heat and/or moisture of the air to be introduced into a vehicle interior being removable by means of the evaporator (36),
a first heat exchanger arrangement (42) downstream of the evaporator (36) in the air flow direction, to supply heat to the air to be introduced into the vehicle interior by means of the first heat exchanger arrangement (42)
a heating arrangement (20) with a second heat exchanger (24), upstream of the evaporator (36) in the air flow direction, to supply heat to air to be introduced into the vehicle interior by means of the second heat exchanger arrangement (24).

2. Temperature control system according to claim 1, wherein
a heat transfer capability of the first heat exchanger arrangement (42) and a heat transfer capability of the second heat exchanger arrangement (24) are variable in a mutually balanced manner.

3. Temperature control system according to claim 2, wherein
the heat transfer capability of the first heat exchanger arrangement (42) is varied by changing the flow guiding of the air to be introduced into the vehicle interior.

4. Temperature control system according to claim 2, wherein
the heat transfer capability of the second heat exchanger arrangement (24) is variable by changing the heating power of a heating arrangement (20).

5. Temperature control system according to claim 1, wherein
the heating arrangement (20) comprises:
a fuel-operated heating device,
an electrically operable heat source,
an auxiliary energy source,
a vehicle drive assembly.

6. Temperature control system according to claim 1, wherein the first heat exchanger arrangement (42) is fed by a cooling system of an internal combustion engine.

7. Temperature control system according to claim 5, wherein the auxiliary energy source comprises a fuel cell or mechanically or thermodynamically operated auxiliary energy source.

8. Method of operating a temperature control system (10) according to claim 1, comprising, simultaneously activating the first heat exchanger arrangement (42) and the second heat exchanger arrangement (24) at least from time to time for transferring heat to the air to be introduced into the vehicle interior.

9. Method according to claim 8, wherein
with the first heat exchanger arrangement (42) activated, when the evaporator (36) is activated, activating the heating arrangement (20) with the second heat exchanger arrangement (24), and reducing the heat transfer capability of the first heat exchanger arrangement (42).

10. Method according to claim 1, comprising using the second heat exchanger arrangement (24) for drying the evaporator (36).
